(19) United States
(12) Patent Application Publication
(10) Pub. No.: US 2011/0056523 A1
(43) Pub. Date: Mar. 10, 2011

(54) METHOD FOR CLEANING THE HEAT EXCHANGER OF A DRYER

(75) Inventors: Klaus Grunert, Berlin (DE); Ulrich Nehring, Berlin (DE); Günter Steffens, Dallgow-Doberitz (DE)

(73) Assignee: BSH BOSCH UND SIEMENS HAUSGERÄTE GMBH, Munich (DE)

(21) Appl. No.: 12/991,456

(22) PCT Filed: May 29, 2009
(86) PCT No.: PCT/EP09/56665

§ 371 Date: Nov. 8, 2010

(30) Foreign Application Priority Data
Jun. 4, 2008 (DE) 10 2008 026 788.0

(51) Int. Cl. B08B 3/00

(52) U.S. Cl. 134/34

(57) ABSTRACT

A method for cleaning a component of a domestic appliance for laundry items. During a cleaning process, a rinsing fluid is at least once conducted through the component. Further, foreign bodies are cleansed from the component. The cleaning process is automatically started and a rinse cycle is performed in which the rinsing fluid is at least once introduced into the component. The rinse cycle is performed after a care process and during a process that prevents creases in the dry laundry items. The dry laundry items are still in the domestic appliance.

The invention relates to a method for cleaning a component of a domestic appliance for the care of laundry items, by which method rinsing fluid is ducted through the component at least once during a cleaning process and the component thereby cleansed of foreign bodies.

Known from documents DE 37 38 031 C2, EP 0 468 573 A1, and DE 199 43 125 A1 are domestic appliances in the form of laundry driers each fitted with a rinsing device having a rinsing fluid for cleaning a heat exchanger. The heat exchanger in a laundry drier of such kind can therein be embodied as an air-to-air heat exchanger or belong to a heat-pump circuit of the laundry drier. Condensate forming while the laundry drier is operating can be collected by the rinsing device as rinsing fluid and ducted during the drying process via the heat exchanger by means of a specific device by, for that purpose, opening a valve between the rinsing-liquid container and heat exchanger. The lint particles that adhere to the heat exchanger and impede the transportation of heat and clog the airways can be removed thereby.

A heat-pump circuit particularly in a laundry drier includes two heat exchangers one of which removes heat from flowing process air and thus functions as a heat sink and the other of which ducts heat to the process air and thus functions as a heat source, as well as a pumping means by which heat is pumped from the heat sink to the heat source. In the known compressor-type heat-pump circuit the pumping means is a circuit in which a working substance circulates. The working substance flows through the heat sink in a liquid state and is evaporated there by absorbing heat from the process air. The heat sink thus functions as an evaporator and is commonly also referred to as such. The evaporated working substance reaches a compressor in the circuit and is compressed there. It then reaches the heat source to be liquefied there while releasing heat into the process air. The heat source thus functions in said heat pump as a condenser and is commonly also referred to as such. The liquid working substance is then expanded in the circuit at a choke, which can be embodied as a valve, nozzle, or capillary, with a reduction in its internal pressure, and finally returns to the evaporator where it evaporates again and where the circuit closes.

The object of the present invention is to provide methods enabling improved cleaning of a component of a domestic appliance for the care of laundry items.

Said object is achieved by means of methods each having the features of one of the independent claims presented herein.

With the inventive method for cleaning a component of the domestic appliance for the care of laundry items according to a first aspect of the invention, rinsing fluid is ducted through the component at least once during the cleaning process and the component cleansed of foreign bodies. The cleaning process is assigned to a specific cleaning program of the domestic appliance. Said cleaning process is started by a user of the domestic appliance by explicitly selecting the cleaning program. A procedure is thus performed here in which the cleaning process is started manually by a user. It is particularly provided for the cleaning program to be selected and hence for the specific cleaning program to be started exclusively by the user's explicit selection. A separate specific cleaning program is hence made available for that purpose to the domestic appliance. The component can hence be cleaned in a user-defined manner at desired times.

The component is embodied preferably as a heat sink, in particular an evaporator, of a heat-pump circuit in the domestic appliance and the heat sink will hence be freed from foreign bodies by the introduction of the rinsing fluid. Said heat-pump circuit also includes a heat source, in particular a condenser.

Foreign bodies accrue very readily and numerously specifically in the heat sink owing to its spatial location in the domestic appliance in the process-air current there so that they have to be removed to enable the functionality of the heat sink and hence also of the domestic appliance as a whole to be sustained.

The component preferably has lint particles as the foreign bodies that are rinsed away by the rinsing fluid. Specifically when the domestic appliance is a laundry drier or washer/drier, lint particles will accrue during the drying process that are torn from the laundry items being dried and carried along in the process-air current.

Preferably ducted through the component as the rinsing fluid is a condensate that forms while the domestic appliance is operating. That embodiment will enable the condensate forming in any event to be put to practical use.

The user is preferably alerted to the need to initiate the cleaning process by an acoustic and/or visual signal generated by the domestic appliance. The user can be given an early indication depending on specific parameters, in particular a lint-accrual level in the component that can be detected via, for instance, a suitable sensor system on the component or elsewhere within the domestic appliance. An excessive accrual of lint can be prevented thereby and the user can always be given the prompt indication for initiating the cleaning program.

A process-air fan of the domestic appliance is preferably switched off during the cleaning process for the duration thereof That will allow the heat sink's front region to be cleaned evenly. It is not, though, absolutely necessary for the process-air fan to be switched off throughout the entire cleaning process. Owing to the air current produced by the process-air fan and to the static and dynamic air pressure caused thereby, the cleaning fluid can possibly be transported as far as the heat source and remove impurities present there.

The rinsing fluid is preferably put into a container belonging to the domestic appliance explicitly by the user him-/herself before the cleaning process is started.

At least one rinse cycle during which rinsing fluid is ducted through the component at least twice at different times is preferably performed during a cleaning process. Ducting rinsing fluid through twice in that way will allow the foreign bodies, particularly the lint particles, to be loosened during a first rinsing operation and rinsed away from the component during the second rinsing operation. Cleaning can be improved thereby and the amount of foreign bodies removed from the component can be significantly increased.

The cleaning process is preferably not started by the user until a running care program has ended; said manual starting by the user will in particular not be possible until said care program has finished. That can prevent the user's starting the cleaning program during undesired phases of a running care program and undesired process overlapping or even functional conflicts among components of the domestic appliance that are then needed for both the cleaning process and the care process can as a result be prevented.

A separate rinse program allows the number of cleaning cycles to be increased so that stubborn dirt will be softened and rinsed away from the component surfaces, in particular the heat-exchanger surfaces. A separate rinse program of such kind is independent of the standard drying program and is specifically chosen by the user. The user is preferably reminded at regular intervals by the domestic appliance's control to start said separate rinse program or cleaning program.

Another aspect of the invention relates to a method for cleaning a component of a domestic appliance for the care of laundry items, by which method rinsing fluid is ducted through the component at least once during a cleaning process and the component is cleansed of foreign bodies. The cleaning process is started automatically and at least one rinse cycle is performed during a care process with the rinsing fluid being introduced at least once into the component as a function of the care level attained for the laundry items. Suitable rinse cycles are thus incorporated into the domestic appliance's automatic and time-based programs and cleaning or, as the case may be, starting and stopping the cleaning process is performed user-independently under automatic control.

Precisely because it is possible to determine the care level attained for the laundry items during a care process, the prerequisite can also be suitably met for enabling the component to be cleaned automatically. It will thereby be possible to initiate and perform cleaning separately and independently at particularly suitable times.

A first rinse cycle with the rinsing fluid being introduced into the component at least once, particularly twice, is preferably performed at a care level at which the laundry items have a first drying degree between 10% and 30%, in particular 15%. Said drying degree is usually described as one that is wringer-to-iron damp. Rinsing specifically at that drying degree has the substantial advantage that at that time, with customary domestic loads and initial dampness levels, sufficient condensate water will usually have accrued which can then be used as rinsing fluid for enabling good rinsing results to be achieved therewith. Moreover, the lint particles that will already have accrued on the front edges of the component, especially the heat exchanger, will at that time not yet have dried out too much as they will still be kept slightly moist by condensate that is running down and so can be rinsed away better.

A second rinse cycle with the rinsing fluid being introduced into the component at least once, particularly twice, is preferably performed at a second drying degree that is greater than the first. For determining the time for starting the second rinse cycle its duration is preferably deducted during the care process from the end time of said process. In particular the time for starting the second rinse cycle is put at less than or equal to five minutes before the end time of the care process. In particular the second rinse cycle is performed for a period of between two minutes and five minutes. The second rinse cycle will hence be performed shortly before the finally set drying level has been reached, which will then be referred to as wardrobe dry, extra dry etc.

In particular two rinsing operations that are performed mutually separated in time are performed during both the first and the second rinse cycle each with a rinsing fluid being introduced. These in each case two rinsing operations will enable the foreign bodies, in particular the lint particles, in each case just to be loosened and then rinsed away. Particularly effective removal of the lint particles will be insured thereby.

Rinsing takes place automatically at suitable times in the case of the second aspect of the invention, with a substantial impact on the cleaning effect on the component being achievable thereby. In particular the focus is therein basically on the end of the care process, especially the selected drying program, because most lint particles accrue there.

Here, too, it is preferably provided for rinsing and hence a cleaning process to be performed with the domestic appliance's process-air fan switched off The corresponding advantages already mentioned above apply here, too.

It can preferably be provided for at least one further rinse cycle with rinsing fluid being introduced into the component at least once after the end of the care process, in particular the drying process, to be performed during a process of the domestic appliance for preventing creasing of the laundry items that are undergoing care and are then, though, still inside the domestic appliance.

Said further rinse cycle is in particular also performed under automatic control. A further rinsing operation is hence preferably performed after drying has finished. The function of the program section employed as standard as the “anti-crease” program section in virtually all driers is to loosen the laundry items at regular intervals by briefly rotating the drum and simultaneously passing air through it so that no creases will form if the user is not present for unloading soon after drying has ended. For example that operation according to this additional process of the domestic appliance for preventing creases in the laundry items can be performed for a period of for instance one to two hours after the actual end of the original care process, in particular the drying process.

Another aspect of the invention relates to a method for cleaning a component of a domestic appliance for the care of laundry items, by which method rinsing fluid is ducted through the component at least once during a cleaning process and the component is cleansed of foreign bodies. The cleaning process is performed under automatic control after the end of a selected care process, in particular a drying process, during a succeeding process of the domestic appliance for preventing creases in the laundry items, in particular the laundry items that have undergone care and been dried. A significant improvement in the cleaning effect and hence in freeing the component from foreign bodies can therefore be insured in the case of this third aspect of the invention also. Said improvement can be achieved here, too, through a specific process design and additional process steps.

A preferred embodiment of the invention in particular regarding the further aspect just explained provides for switching off a process-air fan of the domestic appliance during the cleaning process for the duration thereof. Good and even cleaning of the component in particular in the region against which process air is blown during operation will be insured thereby. It is not, though, necessary for the domestic appliance's process-air fan to be continuously switched off during a cleaning process. Another preferred embodiment of the invention for that purpose provides for the domestic appliance's process-air fan to be switched on during the cleaning process for a part of its duration, with a further component of the domestic appliance being cleaned by the rinsing fluid.

Advantageous embodiments of one aspect of the invention are to be regarded as advantageous embodiments of the respectively other aspects of the invention and vice versa.

Exemplary embodiments of the invention are explained below.

In a first exemplary embodiment it is provided in a method for cleaning a component of a domestic appliance for the care of laundry items, in particular a laundry drier, for rinsing fluid to be ducted at least once during a cleaning process through the component embodied as a heat exchanger, in particular an evaporator, and the evaporator to be cleansed of foreign bodies formed by lint particles. In that first exemplary embodiment the cleaning process is assigned to a specific cleaning program and the cleaning process is started exclusively through the cleaning program's being selected by a user of the domestic appliance.

The domestic appliance embodied as a laundry drier includes a heat pump to which the evaporator is assigned.

For performing the cleaning process, rinsing fluid, in particular water, is then first put by the user into a suitable container, in particular the laundry drier's condensate container. Said specific cleaning program or, as the case may be, separate rinse program is then selected and started by the user.

It can also be provided in the case of this specific method, too, where the cleaning process is performed through the user's making an explicit manual selection, for the condensate container already to be filled automatically with the condensate collected while the laundry drier is operating and for said condensate to be used as rinsing fluid. Explicit filling of said condensate container with water by the customer will not then be necessary.

The cleaning program cannot in the exemplary embodiment be started and selected and hence the cleaning process cannot be started until the drying process performed and selected in advance has finished.

During the cleaning process a rinse cycle will then be performed during which rinsing fluid is ducted through the evaporator. A corresponding display will initially flash on the domestic appliance and the valve which releases or blocks the ducting of rinsing fluid between the condensate container and evaporator will be activated. The pump that pumps the condensate into the condensate container is switched off It is then waited for a specific time to elapse which in the exemplary embodiment is five seconds. The above-mentioned valve is deactivated again when said period has elapsed and the pump switched on for continuous operation. It is consequently waited for a further time to elapse which in the exemplary embodiment is 49 seconds. A pumping cycle is performed directly thereafter during which pumping takes place for a specific period of time, in particular ten seconds, and directly thereafter no pumping is performed for a further specific period of time, in the exemplary embodiment five seconds. Directly after an on-off cycle of such kind it is waited for a further time to elapse, in the exemplary embodiment 69 seconds. Said one-time switch-on, one-time switch-off, one-time waiting cycle is then repeated several times, in particular ten times. Directly thereafter it is again waited for a specific time to elapse, in the exemplary embodiment 48 seconds. Directly thereafter another pumping cycle is performed during which pumping takes place for a specific period of time, in particular 30 seconds, and then directly thereafter no pumping is performed for a further specific period of time, in particular 90 seconds. A signal can thereafter indicate that the end of that specific rinse program has been reached. In particular the condensate container can then be emptied by the user.

In another exemplary embodiment a method for cleaning an evaporator of a laundry drier is performed, by which method rinsing fluid is ducted through the evaporator at least once during a cleaning process and the evaporator is cleansed of lint particles. The cleaning process is started automatically and at least one rinse cycle with rinsing fluid being introduced at least once into the evaporator is performed during a care process as a function of the care level attained for the laundry items. Rinsing is performed in particular only with the process-air fan switched off.

With that automatic rinse cycle, which is integrated in the laundry drier's automatic and time-based programs, a first rinse cycle having two rinsing operations is performed when the wringer-to-iron-damp drying level has been reached, which is the case at a drying degree of between 10% and 30%, in particular 15%. A second rinse cycle is performed at the end of the drying process, with two rinsing operations being performed here, too, one for loosening and the other for rinsing away the lint particles, with that taking place shortly before the finally set drying level has been reached. The drying degree is here preferably wardrobe dry, extra dry etc. That is determined by deducting a specific time duration from the imaginary end time of the drying process during it and then performing the second rinse cycle within said deducted period before the end of the drying process. In particular the second rinse cycle is performed for a period of between two minutes and five minutes.

A rinse cycle comprises twice rinsing in the form of the rinsing operations separated by a specific period as a pause that can be, for example, 120 seconds. Here, too, a “FLU” display is then first shown flashing during a rinse cycle. A motor, embodied preferably for driving the laundry drier's drum and for driving the process-air fan, will then also be switched off like the compressor of the laundry drier's heat pump. Directly thereafter it is waited for a specific time to elapse, in the exemplary embodiment one second. The cited valve will then be activated and the pump for pumping the condensate switched off Directly thereafter it is waited for a specific time to elapse, in the exemplary embodiment five seconds. Directly thereafter the valve will be deactivated and the pump switched on for continuous operation. It is thereafter again waited for a specific time to elapse, in the exemplary embodiment one second. The above-cited motor is then switched on again at the end of the waiting time and it is waited for a specific time to elapse, in particular 49 seconds. After that period another pumping cycle is then performed during which pumping takes place for a specific period of time, in particular 10 seconds, and then pumping is interrupted for a further specific period of time, in particular 5 seconds. Directly after that one pumping cycle it is then waited for a specific time to elapse, in particular 69 seconds. Directly thereafter the motor is switched off. It is then again waited for a specific time to elapse, in particular one second. The valve is reactivated at the end of the waiting time and the pump switched off. Directly thereafter it is again waited for a specific time to elapse, in particular five seconds. Directly thereafter the valve is again deactivated and the pump switched on for continuous operation. That process is then again followed by a waiting time, in particular one second. Directly thereafter the motor is switched on and the compressor likewise switched on. Directly thereafter the “FLU” display is switched off and it is waited for a specific time to elapse, in particular 48 seconds. That waiting time is directly followed by a pumping cycle during which pumping is performed for a specific period of time, in particular 30 seconds, and directly after which pumping is discontinued for a further specific period of time, in particular 90 seconds.

It can furthermore also be provided for at least one further rinse cycle with rinsing fluid being introduced into the evaporator at least once after the end of the drying process to be performed during a process for preventing creases in the already dried laundry items.

In another exemplary embodiment, for cleaning a heat exchanger, in particular an evaporator, of a laundry drier it can be provided for rinsing fluid to be ducted at least once during a cleaning process through the heat exchanger and the heat exchanger to be cleansed of lint particles. The cleaning process is started automatically after the end of a drying process and a further rinse cycle is performed during the cleaning process with rinsing fluid being introduced at least once into the heat exchanger during a process of the laundry drier for preventing creases in the laundry items. Whether a further cleaning process is additionally performed also while the drying process is running has been left open in the case of this further exemplary embodiment and can optionally be provided. Said additional optional cleaning process performed while the drying process is running can then take place in particular in keeping with the above-described functional sequence.

1-16. (canceled)

17. A method for cleaning a component of a domestic appliance for the care of laundry items, the method comprising:
conducting rinsing fluid through the component at least once during a cleaning process; and
cleansing the component of foreign bodies;
wherein the cleaning process is automatically started and a rinse cycle is performed in which the rinsing fluid is at least once introduced into the component; and
wherein the rinse cycle is performed after a care process and during a process for preventing creases in the laundry items that have been dried and are still in the domestic appliance.

18. The method of claim 17, wherein the care process is a drying process.

19. The method of claim 17, wherein the component is a heat sink of a heat-pump circuit.

20. The method of claim 17, wherein the foreign bodies of the component are lint particles that are rinsed away by the rinsing fluid.

21. The method of claim 17, wherein a user introduces the rinsing fluid into a container of the domestic appliance before the cleaning process is started.

22. The method of claim 17, wherein, during the cleaning process, at least one rinse cycle is performed during which the rinsing fluid is conducted at least twice through the component.

23. The method of claim 17, wherein a first rinse cycle is performed at a care level at which the laundry items have a first drying degree between 10% and 30%, and wherein, during the first rinse cycle, the rinsing fluid is at least once introduced into the component.

24. The method of claim 23, wherein the rinsing fluid is twice introduced into the component and wherein the first drying degree is 15%.

25. The method of claim 23, wherein a second rinse cycle is performed at a second drying degree that is greater than the first drying degree, and wherein, during the second rinse cycle, the rinsing fluid is at least once introduced into the component.

26. The method of claim 25, wherein the rinsing fluid is twice introduced into the component.

27. The method of claim 25, wherein, during the care process, the duration of the second rinse cycle is deducted from an end time of the care process in order to determine a start time of the second rinse cycle.

28. The method of claim 27, wherein the start time of the second rinse cycle is less than or equal to 5 minutes before the end time of the care process.

29. The method of claim 17, wherein a further rinse cycle is performed after the care process and during the process for preventing the creases in the laundry items, and wherein, during the further rinse cycle, the rinsing fluid is at least once introduced into the component.

30. The method of claim 29, wherein the care process is a drying process.

31. The method of claim 17, wherein a process-air fan of the domestic appliance is switched off for the duration of the cleaning process.

32. The method of claim 17, wherein a process-air fan of the domestic appliance is switched on during the cleaning process for part of the duration of the cleaning process, and wherein a further component of the domestic appliance is cleaned by the rinsing fluid.
